(19) United States
(12) Patent Application Publication
(10) Pub. No.: US 2013/0293588 A1
(43) Pub. Date: Nov. 7, 2013

(54) METHOD AND DEVICE FOR CONTROLLING ZOOMING OF INTERFACE CONTENT OF TERMINAL

(71) Applicant: Yuan Yu, Beijing (CN)

(72) Inventor: Yuan Yu, Beijing (CN)

(73) Assignee: CHINA MOBILE COMMUNICATIONS CORPORATION, Beijing (CN)

(21) Appl. No.: 13/977,862

(22) PCT Filed: Dec. 31, 2011
(86) PCT No.: PCT/CN2011/085159

§ 371 Date: Jul. 1, 2013

(30) Foreign Application Priority Data
Jan. 4, 2011 (CN) 201110005101.4

(51) Int. Cl. G06T 3/40

(52) U.S. Cl. CPC G06T 3/40
USPC 345/660

(57) ABSTRACT

A method and a device for controlling zooming of interface content of a terminal. The method comprises: sensing a displacement of a terminal between two time points; and performing zooming control on interface content of the terminal according to the displacement. In the present invention, the displacement of the terminal between two points is sensed, and zooming of interface content is controlled according to the displacement, so that the operation is simple, convenient, and not cumbersome, and the zooming efficiency is improved.

This application claims the priority of Chinese patent application No. 201110005101.4, titled “METHOD AND DEVICE FOR CONTROLLING ZOOMING OF INTERFACE CONTENT OF TERMINAL” and filed with the State Intellectual Property Office on Jan. 4, 2011, which is hereby incorporated by reference in its entirety.

### FIELD OF THE INVENTION

The invention relates to the field of terminal control, and in particular to a method and a device for zoom control of interface content of a terminal.

### BACKGROUND OF THE INVENTION

Existing mobile terminals display certain content, such as a web page or a picture, in a way where the displayed object is zoomed out if the content of the displayed object is too large and exceeds the display region of the terminal screen, and the display object needs to be magnified when the details are needed to be observed. Presently, there are mainly two methods for the zooming in or zooming out of the displayed object. The first method is operating by invoking a menu on the interface. This method has disadvantages that multiple clicks on a keyboard or a touch screen are needed to implement the zooming, which causes cumbersome operations and low efficiency, and the presence of the menu on the interface affects the displayed content; moreover, it is difficult to realize zoom control with an accurate point as a center. The second method is operating based on a multi-touch enabled screen, i.e., sliding fingers such as the thumb and the index finger on the touch screen, and the zooming in of the content is performed when the two fingers move away and the zooming out of the content is performed when the two fingers move together. This method needs multiple fingers to participate, which causes inconvenient operations and low efficiency; moreover, it cannot realize zooming with an accurate point as a center, thus lacking of operation accuracy.

### SUMMARY OF THE INVENTION

A first object of the invention is to provide an efficient method for zoom control of interface content of a terminal.

A second object of the invention is to provide an efficient device for zoom control of interface content of a terminal.

In order to achieve the first object above, a method for zoom control of interface content of a terminal is provided according to the invention, the method includes: sensing a displacement of the terminal between two time points; and performing zoom control on the interface content of the terminal according to the displacement.

In order to achieve the second object above, a device for zoom control of interface content of a terminal is provided according to the invention, the device includes: a displacement detecting unit of the terminal, configured to sense a displacement of the terminal between two time points; and a zoom control unit of the terminal, configured to perform zoom control on the interface content of the terminal according the displacement.

In the embodiments of the invention, the displacement of the terminal between two points is sensed, and the zooming of the interface content is controlled according to the displacement. Therefore, the operation is simple and convenient, and the zooming efficiency is improved.

### BRIEF DESCRIPTION OF THE DRAWINGS

The drawings are provided for a further understanding of the invention and constitute a part of the specification. The invention is explained by the drawings together with the embodiments of the invention, and the drawings do not constitute limitations of the invention. In the drawings:

FIG. 1 is a flow chart of a first embodiment of the method for zoom control of interface content of a terminal according to the invention;

FIG. 2 is a flow chart of a second embodiment of the method for zoom control of interface content of a terminal according to the invention;

FIG. 3 is a structural diagram of a first embodiment of the device for zoom control of interface content of a terminal according to the invention; and

FIG. 4 is a structural diagram of a second embodiment of the device for zoom control of interface content of a terminal according to the invention.

### BRIEF DESCRIPTION OF THE DRAWINGS

Preferred embodiments of the invention are illustrated below in conjunction with the drawings. It should be understood that, the preferred embodiments described herein are used only to illustrate and explain the invention, but not used to limit the invention.

### Method Embodiments

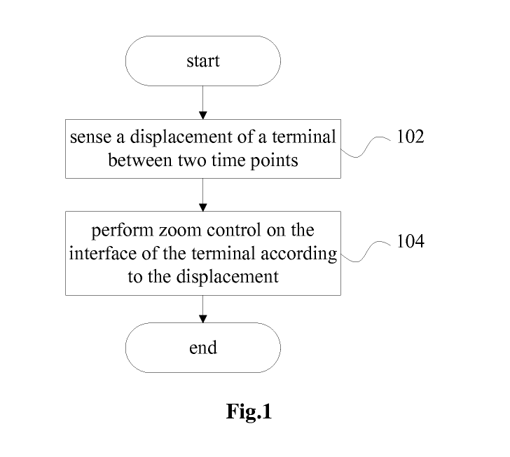

FIG. 1 is a flow chart of a first embodiment of the method for zoom control of interface content of a terminal according to the invention. As shown in FIG. 1, the embodiment includes the following steps.

Step 102: sensing a displacement of the terminal between two time points.

Step 104: performing zoom control on the interface content of the terminal according to the displacement.

In the embodiment, the displacement of the terminal between two points is sensed, and the zooming of the interface content is performed according to the displacement. Therefore, the operation is simple and convenient, and the zooming efficiency is improved.

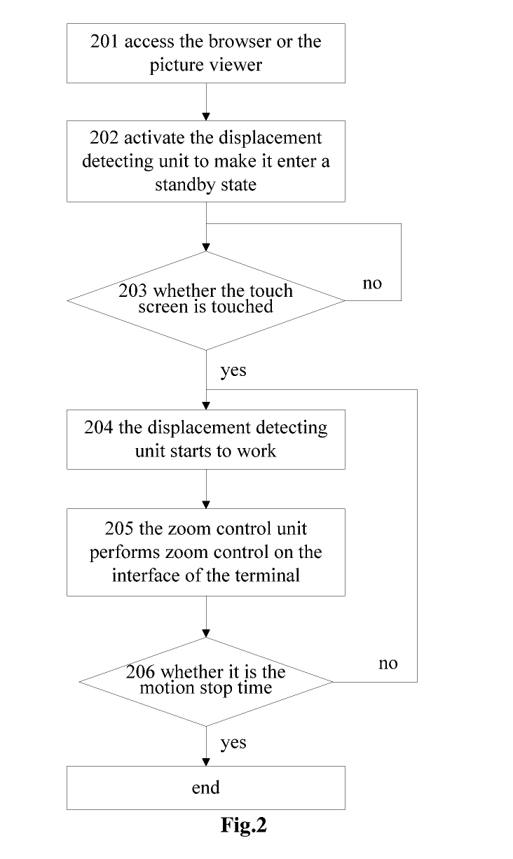

FIG. 2 is a flow chart of a second embodiment of the method for zoom control of interface content of a terminal according to the invention. As shown in FIG. 2, the embodiment includes the following steps.

Step 201: accessing a content viewing program such a browser or a picture viewer in the terminal, to view a web page or a picture.

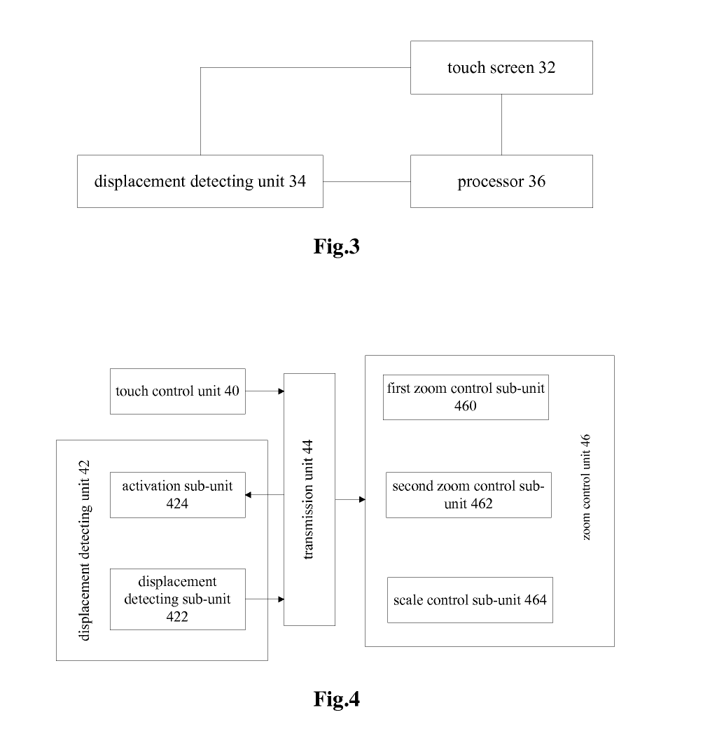

Step 202: activating a displacement detecting unit of the terminal (see explanations of FIG. 3 and FIG. 4 for details), so that the displacement detecting unit enters a standby state to get ready to work.

Step 203: judging whether the touch screen is clicked (i.e., touch information), and if it is determined that there is a click, performing step 204; otherwise, continuing performing step 203.

Step 204: determining a chosen point, i.e., a touch point, on the interface content of the terminal according to the touch information; triggering the displacement detecting unit to make it start to work at the time when the chosen point is determined (this time is determined as a motion start time, i.e., the time when the touch screen is clicked. As a matter of course, in a specific operation, the motion start time for starting the detection of the displacement may be independent from the time when the chosen point is determined. For example, the interface of the terminal may be touched to determine the detection start time, or the motion of the terminal may be sensed and the time when the terminal starts to move is determined as the detection start time, and thus the operation for determining the detection start time is omitted).

In a specific operation, the displacement detecting unit may sense in real time the displacement of the terminal between the motion start time and every motion lasting time until the motion stop time, i.e., continuously sense the displacement between the start time and every time before the motion stop time (including the motion stop time) (correspondingly, the zooming out or zooming in of the interface content is continuously performed in step 205); or, the displacement detecting unit may sense the displacement of the terminal between the motion start time and the motion stop time, that is, only the displacement between the two points, i.e., the start time and the motion stop time, is calculated (correspondingly, the zooming out or zooming in of the interface content is performed only at the motion stop time in the step 205).

The displacement detecting unit may be any one of an acceleration sensor, an ultrasonic detector or a camera. Specific explanations of these displacement detecting units are as follows. For the displacement detecting unit based on acceleration measurement, considering the use's habit when viewing the interface content, i.e., the screen faces the user and moves in a direction away from the user or toward the user, a sensitive axis of the acceleration sensor may be set in a direction perpendicular to the screen (this solution considers the use's habit and is a preferred solution). In this way, when the acceleration sensor works, the displacement in the direction perpendicular to the screen caused by external forces except the gravity may be calculated by removing the effect of the gravity component by calculation. The specific implementation is as follows.

The acceleration sensor may be a three-axis micromachine acceleration sensor (other types of acceleration sensors such as a two-axis micromachine acceleration sensor may be chosen as needed, and it should not be construed as a limitation). In a stationary state of the terminal, the attitude of the terminal in the air is in a certain direction, and angles θ₁, θ₂, θ₃ between the three axes of the three-axis micromachine acceleration sensor and the gravity (assuming the angle between the installation direction and a sensitive axis parallel to a direction perpendicular to the screen (displacement sensitive axis for short) is θ₁) may be calculated according to acceleration values outputted from the three axes, where the angles θ₁, θ₂, θ₃ are the initial attitude angles of the terminal in the air. If the terminal does not rotate in the stationary state or the motion process, i.e., the attitude angles of the terminal are unchanged in the stationary state or the motion process, then for every motion time, a value obtained by subtracting a cosine component of the gravity acceleration at the angle θ₁ from the acceleration output amount on the displacement sensitive axis is the acceleration used to calculate the displacement in the direction of the displacement sensitive axis (the relationship between the acceleration and the displacement is quadratic integral, various approximation algorithms may be employed in specific implementations, and the detailed explanation thereof is as follows in the next paragraph).

If the terminal rotates in the motion process, i.e., the attitude angles of the terminal are changed in the motion process, a gyroscope (various gyroscopes such as a three-axis micromachine gyroscope) may be used to calculate dynamic attitude angles. The initial attitude angle of the terminal in the air may be determined by an acceleration sensor as described in the above paragraph. In the motion process, the three-axis acceleration gyroscope outputs the angular speed ω. For angular speeds at sampling time points (every displacement time), assuming that the initial angular speed is ω_{c}, the sampling time points are T₀, T₁, T₂, . . . Tₙ, the angular speeds corresponding to the time points are ω₀, ω₁, ω₂, . . . ωₙ respectively, and the rotation angles corresponding to the time points are θ₀, θ₁, θ₂, . . . θₙ respectively, the relationship among the sampling time, the angular speed and the rotation angle is shown in formula (1) and formula (2):

θ₀=ω_{c}*T₀ (1)

θₙ=θ₀+ω₃(T₁−T₀)+ω₂*(T₂−T₁)+ . . . +ωₙ*(Tₙ−Tₙ₋₁), n≧1 (2)

If ω_{c}=0, i.e., the initial rotation speed is zero, that is the user keeps the terminal from rotating during the stationary state of the terminal, the rotation angle on each axis (the sensitive axis of the acceleration sensor) may be calculated according to the above-described formulas, so as to obtain the attitude angle of the terminal in the air at any time. The gravity component of the gravity acceleration of the terminal on each sensitive axis of the acceleration sensor at any time is calculated according to the gravity acceleration and the attitude angles (the sensitive axes of the acceleration sensor may be set to coincide with the sensitive axes of the gyroscope respectively). Thus, the acceleration α of the terminal in the direction of each sensitive axis caused by the external force except the gravity is obtained by subtracting the corresponding gravity component from the acceleration output amount of each sensitive axis of the three-axis micromachine acceleration sensor (illustration is made here by taking the acceleration and the displacement in the direction of the displacement sensitive axis as an example). The specific implementation is as follows: assuming that the initial speed of the terminal is C₀, the sampling time points are T₀, T₁, T₂, . . . Tₙ, the accelerations corresponding to the time points are α₀, α₁, α₂, . . . αₙ respectively, and the speeds at the time points are V₀, V₁, V₂, . . . Vₙ respectively, the relationship may be represented by the following formulas:

V₀=Cₙ+T₀*α₀ (3)

Vₙ=V₀+α₁*(T₁−T₀)+α₂(T₂−T₁)+ . . . αₙ(Tₙ−Tₙ₋₁), n≧1 (4)

For the displacement at each time point, various approximation methods may be used, for example:

$$\begin{matrix} {S}_{0} = {C}_{0} * {T}_{0} + \frac{1}{2} {( \frac{{α}_{0}}{2} )}^{2} {T}_{0} & ( 5 ) \\ {S}_{n} = \{ {S}_{0} + {V}_{1} * ( {T}_{1} - {T}_{0} ) + \frac{1}{2} {( \frac{{a}_{1} - {a}_{0}}{2} )}^{2} ( {T}_{1} - {T}_{0} ) + … + {V}_{n - 1} * ( {T}_{n} - {T}_{n - 1} ) + \frac{1}{2} {( \frac{{a}_{n} - {a}_{n - 1}}{2} )}^{2} ( {T}_{n} - {T}_{n - 1} ) n \geq 1 & ( 6 )\end{matrix}$$

In a specific operation, C₀ may be set to 0, i.e., the moving speed of the terminal is zero when the user presses the screen. It should be understood by those skilled in the art that, the sensitive axis of the acceleration sensor may be set in any direction, which is not limited to the direction parallel to the direction perpendicular to the screen; and the zooming of the interface content may be controlled according to the displacements on the multiple sensitive axes of the acceleration sensor.

The ultrasonic detector may be mounted on the same side of the panel and the screen of the terminal in a specific operation. By emitting the ultrasonic wave, the ultrasonic detector may obtain a displacement between the terminal and a reference object (e.g., a person's face) at different time (it should be noted that the reference object at the different time is required to be the same reference object in order to ensure calculation accuracy) when the ultrasonic wave encounters the reference object at different time. The time difference between the reflected wave and the incident wave may be outputted in real time based on the inherent property of the ultrasonic detector itself, thus the displacement between the start time and every motion lasting time until the motion stop time (including the motion stop time) is obtained. In a specific operation, considering the terminal is operated by the hand of a person, so there will be no sudden change in the displacement, therefore the calculation of the displacement may be stopped once there is a sudden change of the ultrasonic wave.

For the camera, scaling of an image of an target object (such as a person's face or eye) between the motion start time and the motion operating time (including every motion lasting time until the motion of the terminal stops) is tracked by real-time shooting, and the displacement of the terminal between the motion start time and the motion operating time is calculated according to a preset correspondence between scalings and distances. Alternatively, the zoom control of the interface content of the terminal is directly performed according to the scaling of the image of the target object between the motion start time and the motion operation time which is sensed by the camera of the terminal.

Specifically, assuming that at the motion start time the camera locks several special positions on the face, such as the eye, the nose or the mouth, and the pixel number or the area of the profile of each special position is calculated. When the terminal or the locked object moves, a scaling factor is obtained by measuring the size or the profile area of each special position in real time, and thus the scaling factor of the displacement is deduced, thereby zoom control of the interface content of the terminal is performed. In a specific operation, when all the special positions are lost, the zooming is stopped with the scaling factor being the last scaling factor before the lost; or when some of the special positions are lost, the calculation is performed according to the remaining special positions.

Step 205, the displacement detecting unit sends the measured displacement to a transmission unit (see the explanations with respect to FIG. 3 and FIG. 4 for details, such as an operation system), and then the transmission unit sends the measured displacement to a zoom control unit (such as a browser or a picture viewer) to perform zoom control on the interface content; meanwhile, the touch screen sends information of a chosen point to the zoom control unit via the transmission unit if the zooming is performed by using the chosen point as a center.

Specifically, the zoom control unit performs, according to the displacement and the chosen point on the interface content of the terminal, zoom control on the interface content of the terminal by using the chosen point as a center. The zoom control unit performs zooming out or zooming in on the interface content of the terminal according to the direction of the displacement, and controls the scaling of the zooming in or zooming out of the interface content of the terminal according to the magnitude of the displacement. For example, zooming in or zooming out when the terminal moves toward the face may be set according to actual needs; furthermore, a control switch may be set to choose two different control modes, where in one mode, zooming in of the interface content is performed when the terminal moves towards the face, and in the other mode, zooming out of the interface content is performed when the terminal moves towards the face; the scaling controlled by the magnitude of the displacement may be set according to actual needs, and for example, no zooming is performed if the movement distance is within 1 cm, the zooming of 5% per 1 cm is performed on the interface content if the movement distance ranges from 1 cm to 5 cm, and the zooming of 10% is performed on the interface content if the movement distance exceeds 5 cm.

Step 206, detecting the motion stop time; notifying the displacement detecting unit to stop working and stop the zooming of the interface content if the motion stop time is detected, then the operation is finished; and performing step 204 if the motion stop time is not detected.

In a specific operation, the motion start time and the motion stop time may be obtained in any ways as set. For example, the time when the touch screen is initially clicked is determined as the motion start time; the time when the user lifts his finger from the touch screen if the real-time zooming reaches a satisfactory zooming effect is set as the motion stop time; or the finger of the user leaves the touch screen directly after clicking, and the time when the user re-clicks the touch screen is set as the motion stop time.

It can be understood by those skilled in the art that, it is a preferred solution in which the zoom control is performed on the interface content of the terminal by using a chosen point as a center, which achieves zooming with an accurate point as a center. It is also a preferred solution in which whether the zooming out or zooming in of the interface content of the terminal is performed is controlled according to the direction of the displacement; however, in an actual operation, it is also possible to perform zooming out if the displacement is within a certain displacement value range and perform zooming in if the displacement is within another displacement value range. It is also a preferred technical solution in which the scaling is controlled according to the displacement value; in an actual operation, the zooming may also be performed according to a preset scale value. It is also a preferred technical solution in which the displacement of the terminal between the motion start time and every motion lasting time until the motion stop time is sensed in real time and the zooming of the interface content is performed in real time, which is convenient for the user to know in real time whether the desired zooming is achieved. It is also a preferred technical solution in which the time when the chosen point is determined is used as the displacement detecting time; moreover, the core of the solution is to control the zooming of the interface content according to the displacement, so it is not limited to sense the displacement when the terminal moves, that is, the sensing of the displacement is not based on the determination of the specific sensing time, the displacement may be sensed at any time, so as to perform zoom control on the interface.

In the embodiment, by adding a displacement detecting unit in a terminal having a touch screen, the terminal can sense in real time the motion displacement of the terminal between two time points, and perform zoom control according to the displacement; moreover, the zooming of the object content can be performed by using a touch point of the touch screen as a center while the motion. The method according to the embodiment can be operated simply and rapidly, and the scaling can be controlled more accurately, thus a better human-computer experience effect is achieved.

### Device Embodiments

FIG. 3 is a structural diagram of a first embodiment of the device for zoom control of interface content of a terminal according to the invention. Each of the method embodiments in FIG. 1 and FIG. 2 may be applied to this embodiment. As shown in FIG. 3, this embodiment includes: a touch screen 32 configured to present user interface content and having at least a single-touch function to determine a chosen point; a displacement detecting unit 34 configured to sense the displacement of the terminal between two time points; a processor 36 including various processing chips, for running an operation system, managing various hardware devices, and running an application program (such as a browser or a picture viewer). The displacement detecting unit 34 may be connected with the processor 36 via a serial peripheral interface (SPI) or an I²C serial bus interface, so as to provide at least single dimensional motion information, i.e., the displacement of the terminal, to the processor 36.

In a specific operation, the displacement detecting unit 34 may be triggered to work when the touch screen 32 is touched or clicked. Further, when the touch screen 32 is triggered, the processor 36 may send a control signal to the displacement detecting unit 34 to control the displacement detecting unit 34 to be activated and to stop work. As illustrated in FIG. 1 and FIG. 2, the displacement detecting unit 34 may be an acceleration sensor, an ultrasonic detector or a camera.

It will be understood by those skilled in the art that, corresponding to the explanation of FIG. 2, the device in the FIG. 3 is a preferred solution of the device embodiments of the invention.

FIG. 4 is a structural diagram of a second embodiment of the device for zoom control of interface content of a terminal according to the invention. Each of the method embodiments in the FIG. 1 and FIG. 2 may be applied to this embodiment. As shown in FIG. 4, the embodiment includes: a displacement detecting unit 42 of the terminal, configured to sense a displacement of the terminal between two time points; a zoom control unit 46 of the terminal (for example but not limited to the browser or the picture viewer in FIG. 3), configured to perform zoom control on the interface content of the terminal according to the displacement. In a specific operation, the device for zoom control of the interface content of a terminal further includes: a touch control unit 40 (such as the touch screen in FIG. 3), configured to determine a corresponding chosen point according to touch information on the interface content of the terminal; and a transmission unit 44 (for example but not limited to the processor in FIG. 3), configured to send the displacement sensed by the displacement detecting unit and the chosen point to the zoom control unit.

The displacement detecting unit 42 may include: a displacement detecting sub-unit 422, configured to sense in real time the displacement of the terminal between a motion start time and every motion lasting time until the motion stop time of the terminal, or sense the displacement of the terminal between the motion start time and the motion stop time, where the motion start time is the time when the chosen point is determined on the interface content of the terminal; and an activation sub-unit 424, configured to trigger the displacement detecting sub-unit 422 to work when the touch control unit determines the chosen point.

The transmission unit 44 may include: a first transmission unit (not shown), configured to send the displacement sensed by an acceleration sensor, an ultrasonic detector or a camera and the chosen point to the zoom control unit 46; a second transmission unit (not shown), configured to send scaling of an image of a target object between two time points which is sensed by the camera to the zoom control unit for performing zoom control on the interface content of the terminal.

The zoom control unit 46 may include: a first zoom control sub-unit 460, configured to perform, according to the displacement and the chosen point of the interface content, zoom control on the interface content of the terminal by using the chosen point of the interface content as a center; a second zoom control sub-unit 462, configured to perform zooming out or zooming in on the interface content of the terminal according to a direction of the displacement; and a scale control sub-unit 464, configured to control the scaling of the zooming out or zooming in of the interface content of the terminal according the magnitude of the displacement.

As the explanation of each of the embodiments in FIG. 1 to FIG. 3, the displacement detecting unit may include (not shown):

an acceleration sensor, configured to sense the displacement of the terminal in a direction perpendicular to the screen of the terminal between two time points, preferably configured to sense in real time the displacement of the terminal in a direction perpendicular to the screen of the terminal between a motion start time and every motion lasting time until the motion stop time of the terminal; or sense the displacement of the terminal in a direction perpendicular to the screen of the terminal between the motion start time and the motion stop time; or

an ultrasonic sensor, configured to sense the displacement of the terminal between two time points with reference to a same reference object; or

a camera, configured to sense scaling of an image of a target object between two time points, and calculate the displacement of the terminal between the two time points according to a preset correspondence between scalings and distances.

In the embodiment, by embedding the displacement detecting unit 42 in the terminal and triggering the displacement detecting unit 42 to work at the time when a certain determined point (i.e., the chosen point) on the touch control unit 40 is clicked, zoom control of interface content is achieved according to the magnitude and direction of the displacement when the terminal moves, therefore the operation efficiency of the interface content zooming is improved, furthermore, the zooming accuracy is improved since the zooming of the interface content is performed by using the determined point as a center.

Finally, it should be noted that the above-disclosed are only preferred embodiments of the invention, and are not intended to limit the invention. Although the invention is illustrated in detail with reference to the embodiments described above, those skilled in the art can make modifications to the technical solution in the embodiments mentioned above, or substitute equivalent features for some of the technical features. Any changes, equivalents or modifications made within the spirit and principle of the invention should be included in the protection scope of the invention.

1. A method for zoom control of interface content of a terminal, comprising:
sensing a displacement of the terminal between two time points; and
performing zoom control on the interface content of the terminal according to the displacement.

2. The method for zoom control of interface content of a terminal according to claim 1, wherein the performing zoom control on the interface content of the terminal according to the displacement comprises:
performing, according to the displacement and a chosen point on the interface content of the terminal, zoom control on the interface content of the terminal by using the chosen point as a center.

3. The method for zoom control of interface content of a terminal according to claim 1, wherein the performing zoom control on the interface content of the terminal according to the displacement comprises:
performing zooming in or zooming out on the interface content of the terminal according to a direction of the displacement.

4. The method for zoom control of interface content of a terminal according to claim 3, wherein the performing zoom control on the interface content of the terminal according to the displacement comprises:
controlling the scaling of the zooming in or zooming out of the interface content of the terminal according to the magnitude of the displacement.

5. The method for zoom control of interface content of a terminal according to claim 1, wherein the sensing a displacement of the terminal between two time points comprises:
using the time point when the interface content of the terminal is touched as a motion start time;
sensing in real time the displacement of the terminal between the motion start time and every motion lasting time until a motion stop time of the terminal; or sensing the displacement of the terminal between the motion start time and the motion stop time of the terminal.

6. The method for zoom control of interface content of a terminal according to claim 5, wherein the time point when the interface content of the terminal is touched is a time point when the chosen point is determined on the interface content of the terminal.

7. The method for zoom control of interface content of a terminal according to claim 5, wherein the sensing in real time the displacement of the terminal between the motion start time and every motion lasting time until a motion stop time of the terminal, or sensing in real time the displacement of the terminal between the motion start time and the motion stop time of the terminal comprises:
sensing in real time, by an acceleration sensor of a terminal, the displacement of the terminal in a direction perpendicular to a screen of the terminal between the motion start time and every motion lasting time until the motion stop time of the terminal; or
sensing in real time, by an acceleration sensor of the terminal, the displacement of the terminal in a direction perpendicular to the screen of the terminal between the motion start time and the motion stop time of the terminal.

8. The method for zoom control of interface content of a terminal according to claim 1, wherein the sensing a displacement of the terminal between two time points comprises:
sensing, by an acceleration sensor of the terminal, the displacement of the terminal between the two time points; or
sensing, by an ultrasonic detector of the terminal, the displacement of the terminal between the two time points with respect to a same reference object; or
sensing, by a camera of the terminal, a scaling of an image of a target object between the two time points, and calculating the displacement of the terminal between the two time points according to a preset correspondence between scalings and distances.

9. The method for zoom control of interface content of a terminal according to claim 8, further comprising:
performing zoom control on the interface content of the terminal according to the scaling of the image of the target object between the two time points sensed by the camera of the terminal.

10. A device for zoom control of interface content of a terminal, comprising:
a displacement detecting unit of the terminal, configured to sense a displacement of the terminal between two time points; and
a zoom control unit of the terminal, configured to perform zoom control on the interface content of the terminal according the displacement.

11. The device for zoom control of interface content of a terminal according to claim 10, further comprising:
a touch control unit, configured to determine a corresponding chosen point according to touch information on the interface content of the terminal, and
a transmission unit, configured to send the displacement sensed by the displacement detecting unit and the chosen point to the zoom control unit.

12. The device for zoom control of interface content of a terminal according to claim 11, wherein the zoom control unit comprises:
a first zoom control sub-unit, configured to perform, according to the displacement and the chosen point, zoom control on the interface content of the terminal by using the chosen point as a center.

13. The device for zoom control of interface content of a terminal according to claim 10, wherein the zoom control unit further comprises:
a second zoom control sub-unit, configured to perform zooming in or zooming out on the interface content of the terminal according to a direction of the displacement.

14. The device for zoom control of interface content of a terminal according to claim 13, wherein the zoom control unit further comprises:
a scale control sub-unit, configured to control the scaling of the zooming in or zooming out of the interface content of the terminal according to the magnitude of the displacement.

15. The device for zoom control of interface content of a terminal according to claim 10, wherein the displacement detecting unit comprises:
a displacement detecting sub-unit, configured to sense in real time the displacement of the terminal between a motion start time and every motion lasting time until a motion stop time of the terminal, or sense the displacement of the terminal between the motion start time and the motion stop time of the terminal, wherein the motion start time is a time point when a chosen point is determined on the interface content of the terminal; and
an activation sub-unit, configured to trigger the displacement detecting sub-unit to work at the time when the chosen point is determined by the touch control unit.

16. The device for zoom control of interface content of a terminal according to claim 15, wherein the displacement detecting sub-unit is an acceleration sensor, configured to sense in real time the displacement of the terminal in a direction perpendicular to a screen of the terminal between the motion start time and every motion lasting time until the motion stop time of the terminal; or sense the displacement of the terminal in a direction perpendicular to the screen of the terminal between the motion start time and the motion stop time of the terminal.

17. The device for zoom control of interface content of a terminal according to claim 10, wherein the displacement detecting unit comprises:
an acceleration sensor, configured to sense the displacement of the terminal between the two time points; or
an ultrasonic detector, configured to sense the displacement of the terminal between the two time points with respect to a same reference object; or
a camera, configured to sense a scaling of an image of a target object between the two time points, and calculate the displacement of the terminal between the two time points according to a preset correspondence between scalings and distances.

18. The device for zoom control of interface content of a terminal according to claim 17, wherein the transmission unit comprises:
a first transmission unit, configured to send the displacement sensed by the acceleration sensor, the ultrasonic detector or the camera and the chosen point to the zoom control unit; and
a second transmission unit, configured to send the scaling of the image of the target object between the two time points which is sensed by the camera to the zoom control unit for zoom control of the interface content of the terminal.

19. The method for zoom control of interface content of a terminal according to claim 2, wherein the performing zoom control on the interface content of the terminal according to the displacement comprises:
performing zooming in or zooming out on the interface content of the terminal according to a direction of the displacement.

20. The device for zoom control of interface content of a terminal according to claim 12, wherein the zoom control unit further comprises:
a second zoom control sub-unit, configured to perform zooming in or zooming out on the interface content of the terminal according to a direction of the displacement.
